(19) United States
(12) Patent Application Publication
(10) Pub. No.: US 2026/0045803 A1
(43) Pub. Date: Feb. 12, 2026

(54) CHARGING MODULE AND BATTERY CHARGING CASE

(71) Applicant: Shenzhen Obuy Technology Co., Ltd, Shenzhen (CN)

(72) Inventors: QI YUAN, Shenzhen (CN); OU YANG, Shenzhen (CN); MANCHUN CAI, Shenzhen (CN); ZIYANG ZHOU, Shenzhen (CN)

(21) Appl. No.: 19/015,988

(22) Filed: Jan. 10, 2025

(30) Foreign Application Priority Data
Aug. 7, 2024 (CN) 202411074195.4

(51) Int. Cl. H02J 7/00

(52) U.S. Cl. CPC H02J 7/00045; H02J 7/0042

(57) ABSTRACT

The present application discloses a charging module and a battery charging case, wherein the charging module includes a charging compartment, a screening assembly, and a second drive assembly. The charging compartment includes a compartment body and a first bracket, and the first bracket is installed in the chamber of the compartment body and includes a battery installation through slot for accommodating the batteries to be charged. The screening assembly is installed on the first bracket and located at a discharging side of the battery installation through slot, and includes a screening port for the battery to flow through. The second drive assembly is installed on the first bracket and is drivingly connected to the screening assembly, and is configured to drive the screening assembly to move along the width direction of the battery charging case.

### CROSS-REFERENCE TO RELATED APPLICATIONS

This application claims priority to Chinese Patent Application No. 202411074195.4, filed on Aug. 7, 2024, which is hereby incorporated by reference in its entirety.

### TECHNICAL FIELD

The present application relates to the field of battery charging technology, particularly to a charging module and a battery charging case.

### BACKGROUND

The battery charging case includes a charging module for charging the batteries to be charged, and the batteries to be charged include batteries that meet the model requirements and the ones that do not meet the model requirements, and the charging module can only charge the ones that meet the model requirements. However, the charging module in related technologies cannot effectively screen batteries that do not meet the model requirements and when batteries that do not meet the model requirements are mixed into the charging compartment of the charging module, users can only manually remove the batteries that do not meet the model requirements from the charging compartment of the charging module, which is cumbersome and inconvenient for users. Therefore, how to enable the charging module to effectively screen the batteries to be charged that do not meet the model requirements has become an urgent problem to be solved.

### SUMMARY

The present embodiment provides a charging module and a battery charging case, which can solve the problem that the charging module in related technologies cannot effectively screen the batteries to be charged that do not meet the model requirements of the model.

In the first aspect, the embodiment of the present application discloses a charging module; the charging module is used for a battery charging case, comprises a charging compartment, a screening assembly, and a second drive assembly; the charging compartment includes a compartment body and a first bracket, and the first bracket is installed in the chamber of compartment body and comprises a battery installation through slot for accommodating the batteries to be charged, the screening assembly is installed on the first bracket and located at a discharging side of the battery installation through slot, and comprises a screening port for the battery to flow through, and the second drive assembly is installed on the first bracket and is drivingly connected to the screening assembly, and is configured to drive the screening assembly to move along the width direction of the battery charging case, and when the screening assembly moves to the screening port to align with the battery installation through slot, batteries that meet model requirements can pass through the screening port; when the screening assembly moves to the screening port to be offset from the battery installation through slot, batteries that do not meet model requirements can pass through the screening port.

In the second aspect, the embodiment of the present application provides a battery charging case; the battery charging case comprises a feeding module, a discharging module, and the aforementioned charging module, and the feeding module is used to accommodate the batteries to be charged, while the discharging module is used to accommodate fully charged batteries; the discharging port of the feeding module is connected to the feeding port of compartment body, and the discharging port of compartment body is connected to the feeding port of discharging module.

Based on the charging module and battery charging case in the embodiment of the present application, the second drive assembly drives the screening assembly to move along the width direction of the battery charging case, and when the screening assembly moves to the screening port to be offset from the battery installation through slot, the screening assembly will cause incomplete obstruction to the discharging side of the battery installation through slot, the battery installation through slot and the screening port are not fully connected, and the batteries to be charged in the battery installation through slot that does not meet the model requirements can, under their own gravity, pass through the screening port in the small gap formed by the incompletely connected battery installation through slot and the screening port. Due to the obstruction of screening assembly, the batteries in the battery installation through slot that meet the model requirements, under their own gravity, cannot pass through the screening port through the small gap formed by the incompletely connected battery installation through slot and the screening port, such that the batteries to be charged that do not meet the model requirements can be effectively screened. When the screening assembly moves to the screening port to align with the battery installation through slot, the screening assembly will not obstruct the discharging side of the battery installation through slot that is fully connected to the screening port, and the batteries in the battery installation through slot that meet the model requirements can pass through the screening port under their own gravity.

### BRIEF DESCRIPTION OF DRAWINGS

In order to provide a clearer explanation of the technical solution of the embodiments of the present application, the accompanying drawings required for the description of the embodiments will be briefly introduced below. Obviously, the accompanying drawings described below are some embodiments of the present invention, and those of ordinary skill in the art can also obtain other drawings based on these ones without creative labor.

FIG. 1 is a structure diagram of a cross-section of a charging module in one embodiment of the present application;

FIG. 2 is a structure diagram of a screening assembly and a second drive assembly installed on a first bracket in one embodiment of the present application;

FIG. 3 is a structure diagram of FIG. 2 from another perspective;

FIG. 4 is an exploded structure diagram of FIG. 3;

FIG. 5 is a structure diagram of FIG. 4 from another perspective;

FIG. 6 is a structure diagram of a screening plate in the initial state in one embodiment of the present application;

FIG. 7 is a structure diagram of a screening plate in one embodiment of the present application when moving to a first screening port to align with a first through slot;

FIG. 8 is a structure diagram of a screening plate in one embodiment of the present application when moving to a first screening port to align with a second through slot;

FIG. 9 is a structure diagram of a screening plate in one embodiment of the present application when moving to a second screening port to align with a third through slot;

FIG. 10 is a structure diagram of a screening plate in one embodiment of the present application when moving to a second screening port to align with a fourth through slot;

FIG. 11 is a structure diagram of a battery charging case in one embodiment of the present application.

Marks in the attached drawings: 1. Battery charging case; XX′, length direction; YY′, width direction; ZZ′, height direction; 10. Feeding module; 11. Feeding compartment; 20. Charging module; 21. Charging compartment; 211. Compartment body; 212. First bracket; 212a. Battery installation through slot; 212a1. First through slot; 21a2. Second through slot; 212a3. Third through slot; 212a4. Fourth through slot; 25. Screening assembly; 251. Screening plate; 251a, Screening port; 251a1, First screening port; 251a2, Second screening port; 2511. Plate body; 2512. blocking plate; 2512a, Hollow hole; 252. Transmission rack; 253. buffers; 2531. Buffer partition; 26. Second drive assembly; 261. Second motor; 262. Transmission gear; 27. Limit structure; 271. Limit flange; 272. Limit groove; 30. Discharging module; 31. Discharging compartment.

### DESCRIPTION OF EMBODIMENTS

In order to make the purpose, technical solution, and advantages of the present application clearer and more understandable, further detailed explanations of the present application will be provided in conjunction with the accompanying drawings and embodiments. It should be understood that the specific embodiments described herein are only used to explain, rather than limit the present application.

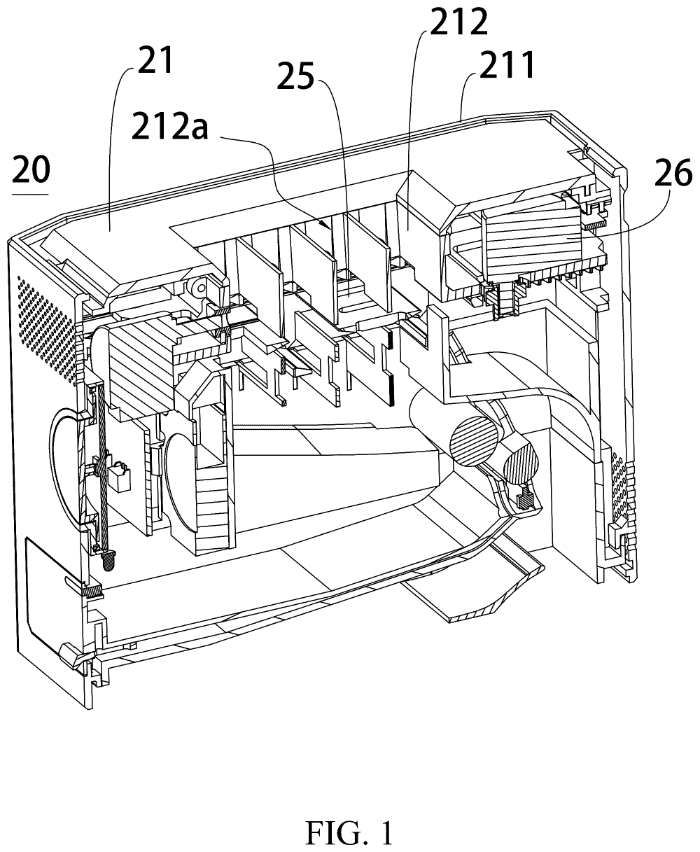

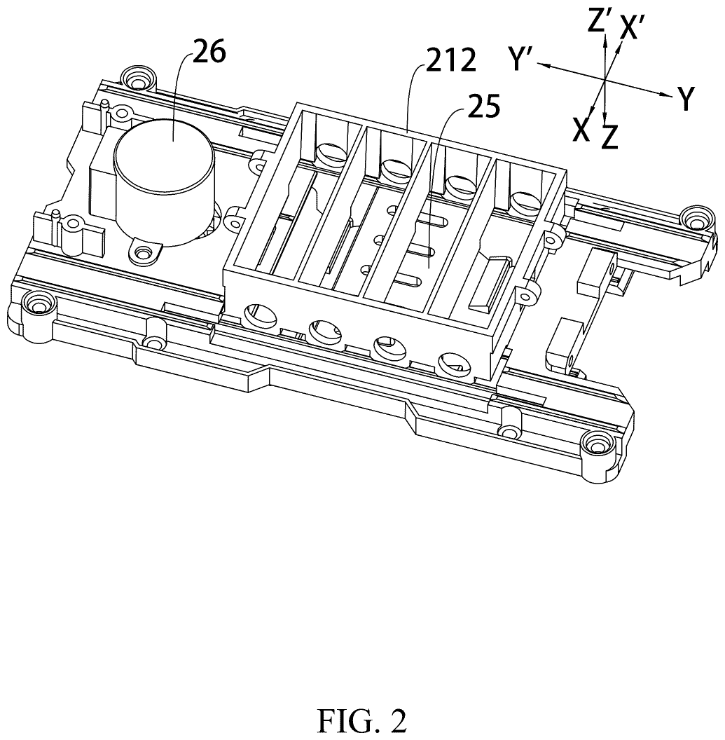

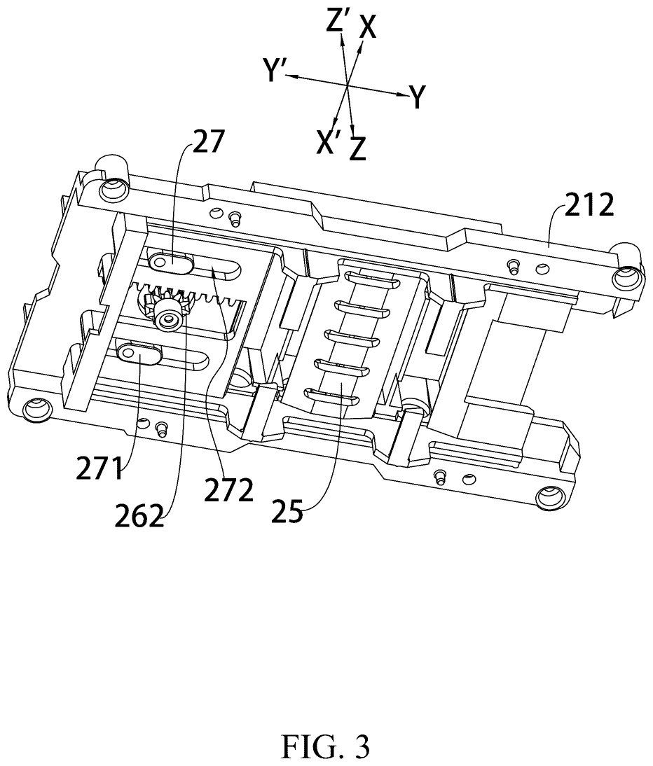

As shown in FIG. 1-3, in the first aspect, the present application proposes a charging module 20 that can effectively screen batteries to be charged that do not meet model requirements.

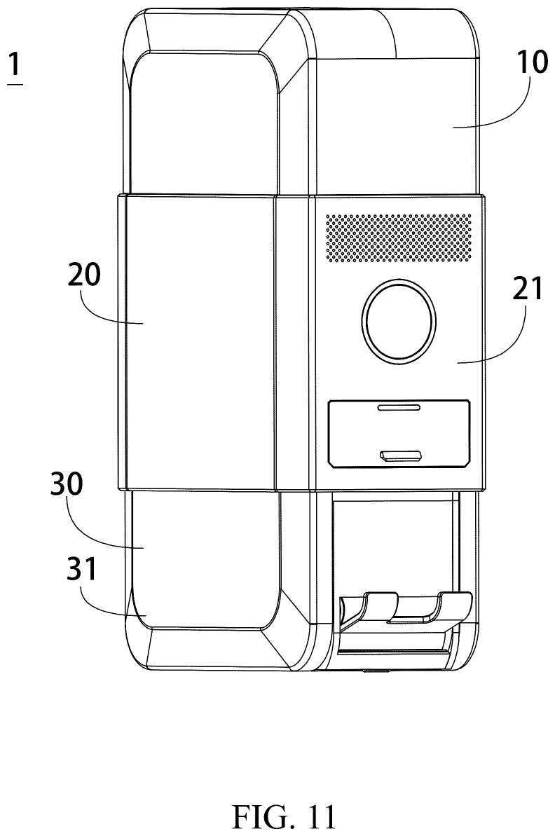

The charging module 20 is used for the battery charging case 1 (as shown in FIG. 11), and the charging module 20 comprises a charging compartment 21, a screening assembly 25, and a second drive assembly 26. The charging compartment 21 comprises a compartment body 211 and a first bracket 212, the first bracket 212 is installed in the chamber of the compartment body 211 and comprises a battery installation through slot 212a for accommodating the batteries to be charged. The screening assembly 25 is installed on the first bracket 212 and located at a discharging side of the battery installation through slot 212a, the screening assembly 25 comprises a screening port 251a for the battery to flow through. The second drive assembly 26 is installed on the first bracket 212 and is drivingly connected to the screening assembly 25, the second drive assembly 26 is configured to drive the screening assembly 25 to move along a width direction YY′ of the battery charging case 1; when the screening assembly 25 moves to the screening port 251a to align with the battery installation through slot 212a, batteries that meet model requirements can pass through the screening port 251a; when the screening assembly 25 moves to the point where the screening port 251a is offset from the battery installation through slot, batteries that do not meet model requirements can pass through the screening port 251a.

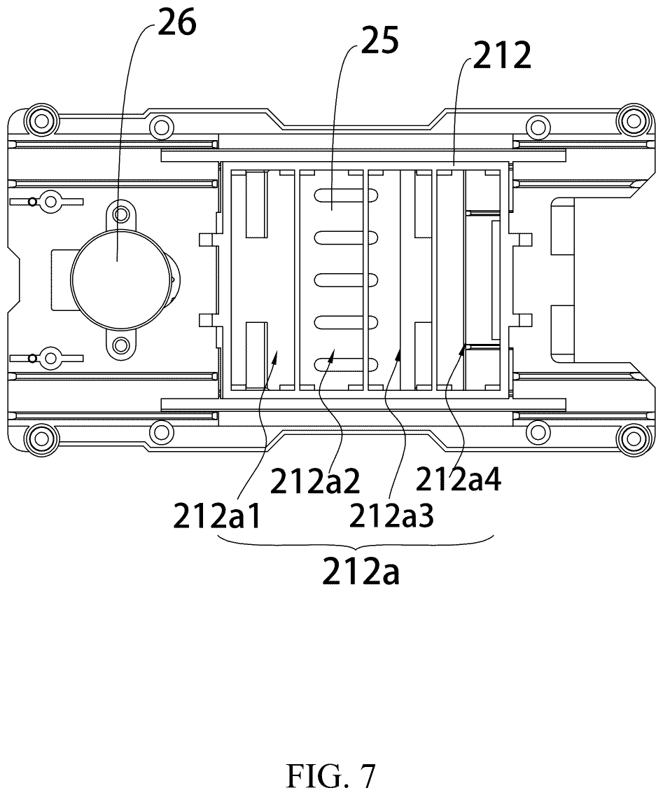

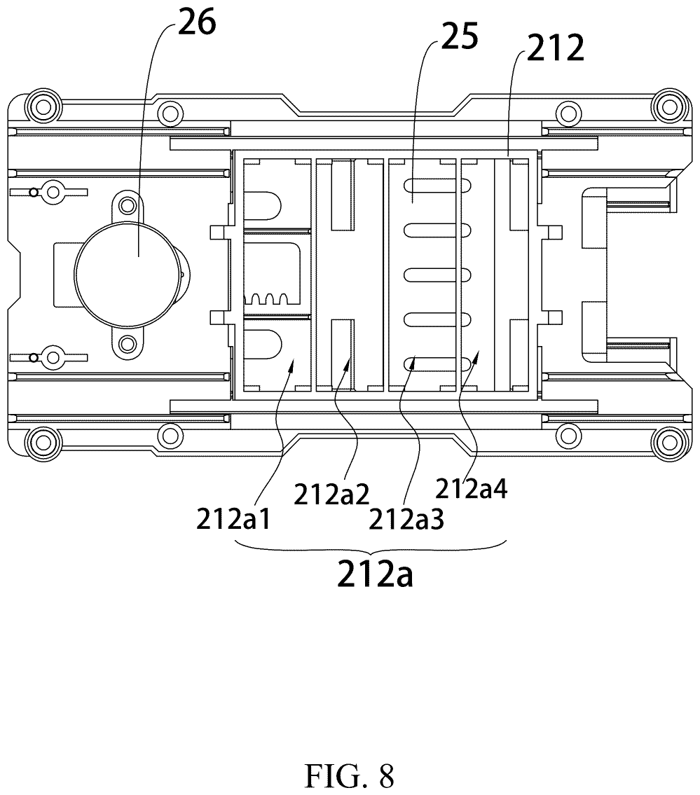

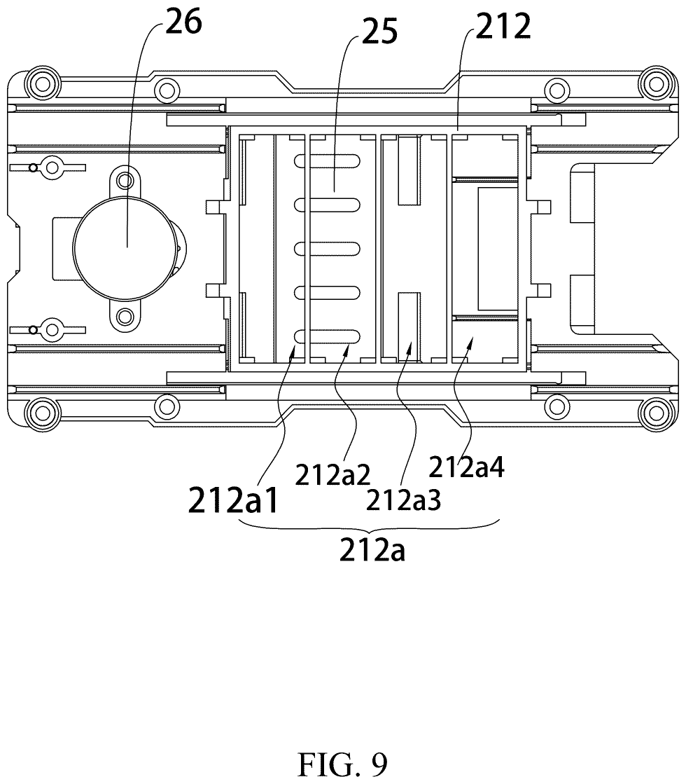

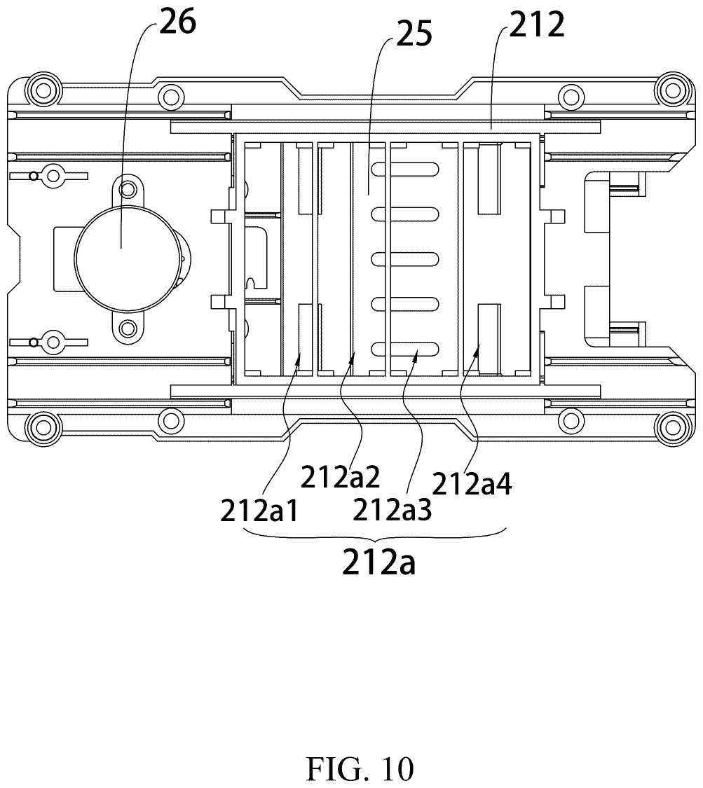

The specific structure of the battery charging case 1 will be described below in conjunction with FIG. 1-10.

As shown in FIG. 1-3, the charging module 20 comprises a charging compartment 21, a screening assembly 25, and a second drive assembly 26.

On the one hand, as the outer shell of charging module 20, the charging compartment 21 comprises a compartment body 211 and, for example, the outer contour shape of compartment body 211 can be, but is not limited to, a rectangular prism or a cylindrical prism; the specific preparation material of the compartment body 211, can be, but is not limited to, plastic cement or one of the plastics. Designing the preparation material of compartment body 211 as plastic cement or plastics can effectively reduce the cost of the battery charging case 1.

On the other hand, as the bracket of charging module 20, the charging compartment 21 also comprises a first bracket 212; the specific preparation material of the first bracket 212 can be, but is not limited to, plastic cement or one of the plastics.

The first bracket 212 comprises a battery installation through slot 212a for accommodating batteries to be charged; “the battery installation through slot 212a” refers to an area on the first bracket 212 used to place the batteries to be charged; the batteries to be charged that flow out from the discharging port of the feeding module 10 (as described below) of the battery charging case 1 will directly fall into the battery installation through slot 212a of the first bracket 212 after entering the chamber of the compartment body 211 through the feeding port of compartment body 211.

The first bracket 212 is installed in the chamber of the compartment body 211, the first bracket 212 and the compartment body 211 can be specifically connected as follows, for example, when the first bracket 212 is detachably connected to the compartment body 211, the first bracket 212 can be fixedly connected to the compartment body 211 through at least one of screw connection, snap-in connection, or plug-in connection and, for example, when the first bracket 212 is non detachably connected to the compartment body 211, the first bracket 212 can be fixedly connected to the compartment body 211 through, but not limited to, adhesive bonding.

As shown in FIG. 1-3, understandably, the batteries to be charged stored in the feeding compartment 11 of the feeding module 10 of the battery charging case 1 include batteries to be charged that meet the model requirements and batteries to be charged that do not meet the model requirements, and both batteries to be charged that meet the model requirements and batteries to be charged that do not meet the model requirements will flow out of the discharging port of the feeding module 10 and into the chamber of the feeding compartment 11 of the feeding module 10 through the feeding port of compartment body 211, thereby directly falling into the battery installation through slot 212a of the first bracket 212, while the charging assembly of charging module 20 (not shown in the drawing, serving as the structural component of charging module 20 to charge the batteries to be charged, which is not elaborated here) can only charge the batteries to be charged that meet model requirements. Therefore, the screening assembly 25 is used as a structural component of the charging module 20 to effectively screen out the batteries to be charged that fall into the battery installation through slot 212a the ones that meet model requirements and the ones that do not meet model requirements; the specific structure of screening assembly 25 will be introduced below.

The screening assembly 25 is installed on the first bracket 212 and located at the discharging side of the battery installation through slot 212a; the battery installation through slot 212a comprises an opening into which the batteries to be charged will flow and another opening from which the batteries to be charged will flow out; “discharging side of the battery installation through slot 212a” refers to the side where the other opening of the battery installation through slot 212a from which the batteries to be charged flow out.

The screening assembly 25 comprises a screening port 251a for the batteries to flow through, the shape and size of screening port 251a fit with the batteries to be charged that meet the model requirements and, taking the AA and AAA batteries as examples, the AA batteries, larger ones, are defined as the batteries to be charged that meet the model requirements, while the AAA batteries, smaller ones, are defined as the batteries to be charged that does not meet the model requirements, and the shape and size of the screening port 251a is adapted to the shape and size of the AA batteries. It should be noted that the size of the batteries to be charged that meet the model requirements is larger than that of the ones that do not meet the model requirements.

As shown in FIG. 1-3, the second drive assembly 26 serves as a structural component of charging module 20 to drive the screening assembly 25 to move along the width direction YY′ of the battery charging case 1; the specific structure of the second drive assembly 26 will be introduced below.

The second drive assembly 26 is installed on the first bracket 212 and is drivingly connected to the screening assembly 25, so as to transfer the driving force generated by the second drive assembly 26 to the screening assembly 25, such that the screening assembly 25 moves along the width direction YY′ of the battery charging case 1, effectively screening the batteries to be charged that meet the model requirements and those that do not meet the model requirements.

When the screening assembly 25 moves to the screening port 251a to align with the battery installation through slot 212a, the batteries that meet the model requirements can pass through the screening port 251a, the screening assembly 25 will not obstruct the discharging side of the battery installation through slot 212a that is fully connected to the screening port 251a, and the batteries in the battery installation through slot 212a that meet the model requirements can pass through the screening port 251a under their own gravity. It should be noted that the batteries to be charged that meet the model requirements can first pass through the screening port 251a under their own gravity and fall into a certain intermediate transition position where the charging assembly of charging module 20 will then charge the batteries to be charged that meet the model requirements and, alternatively, the charging assembly of charging module 20 can first charge the batteries to be charged that meet the model requirements and fall into the battery installation through slot 212a and, after being fully charged, the fully charged batteries that meet the model requirements can pass through the screening port 251a under their own gravity, that is to say, the batteries passing through the screening port 251a that meet model requirements can be the batteries to be charged that meet the model requirements, or the fully charged batteries that meet the model requirements. It is noteworthy that when the screening assembly 25 moves to the screening port 251a to align with the battery installation through slot 212a, small batteries to be charged that do not meet model requirements can also pass through the screening port 251a.

When the screening assembly 25 moves to the screening port 251a to be offset from the battery installation through slot 212a, the batteries to be charged that do not meet the model requirements can pass through the screening port 251a, and the screening assembly 25 will cause incomplete obstruction to the discharging side of the battery installation through slot 212a, the battery installation through slot 212a and the screening port 251a are not fully connected, and the batteries to be charged in the battery installation through slot 212a that does not meet the model requirements can, under their own gravity, pass through the screening port 251a in the small gap formed by the incompletely connected battery installation through slot 212a and the screening port 251a. Due to the obstruction of screening assembly 25, the batteries in the battery installation through slot 212a that meet the model requirements, under their own gravity, cannot pass through the screening port 251a in the small gap formed by the incompletely connected battery installation through slot 212a and the screening port 251a.

It should be noted that for the single charging process of charging module 20, in the initial state, the screening assembly 25 is in the preset position, and at the preset position, the screening assembly 25 partially blocks the battery installation through slot 212a, and the screening port 251a is offset from the battery installation through slot 212a. The batteries to be charged that do not meet the model requirements, when falling into the battery installation through slot 212a at this time, can, under their own gravity, pass through the screening port 251a in the small gap formed by the incompletely connected battery installation through slot 212a and the screening port 251a. The batteries to be charged that meet the model requirements, when falling into the battery installation through slot 212a at this time, cannot, under their own gravity, pass through the screening port 251a in the small gap formed by the incompletely connected battery installation through slot 212a and the screening port 251a.

Based on the charging module 20 in the embodiment of the present application, the second drive assembly 26 drives the screening assembly 25 to move along the width direction YY of the battery charging case 1, and when the screening assembly 25 moves to the screening port 251a to be offset from the battery installation through slot 212a, the screening assembly 25 will cause incomplete obstruction to the discharging side of the battery installation through slot 212a, the battery installation through slot 212a and the screening port 251a are not fully connected, and the batteries to be charged in the battery installation through slot 212a that does not meet the model requirements can, under their own gravity, pass through the screening port 251a in the small gap formed by the incompletely connected battery installation through slot 212a and the screening port 251a. Due to the obstruction of screening assembly 25, the batteries in the battery installation through slot 212a that meet the model requirements, under their own gravity, cannot pass through the screening port 251a through the small gap formed by the incompletely connected battery installation through slot 212a and the screening port 251a, such that the batteries to be charged that do not meet the model requirements can be effectively screened. When the screening assembly 25 moves to the screening port 251a to align with the battery installation through slot 212a, the screening assembly 25 will not obstruct the discharging side of the battery installation through slot 212a which is fully connected to the screening port 251a, and the batteries in the battery installation through slot 212a that meet the model requirements can pass through the screening port 251a under their own gravity.

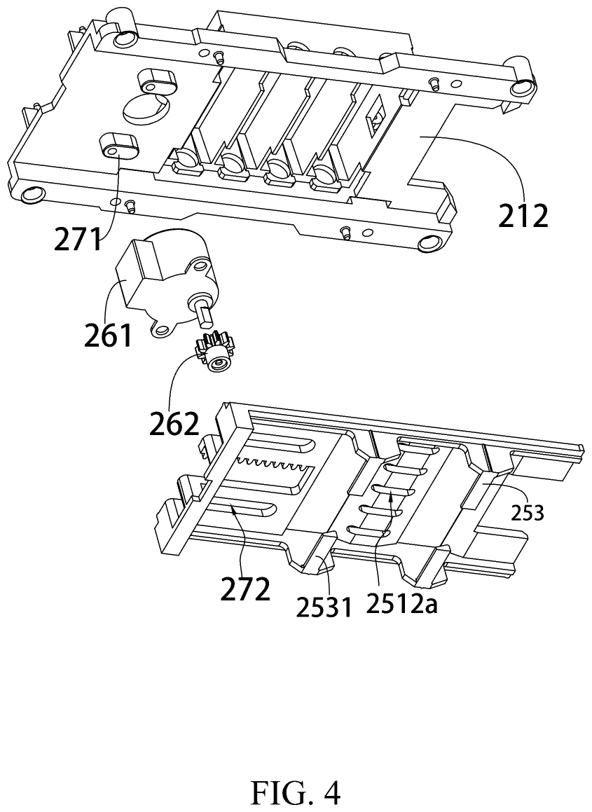

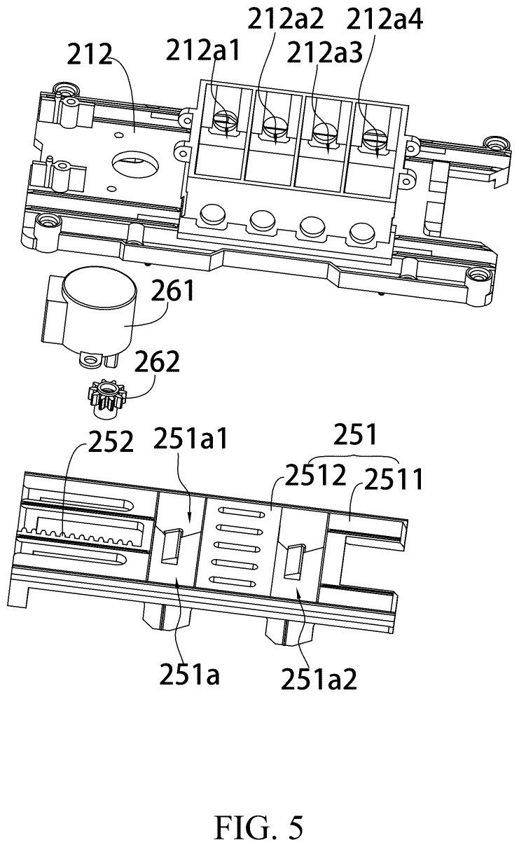

Further, as shown in FIG. 4-5, the screening assembly 25 comprises a screening plate 251 and a transmission rack 252; the screening plate 251 extends along the width direction YY′ of the battery charging case 1 and is slide connected to the first bracket 212, and comprises a screening port 251a; the transmission rack 252 extends along the width direction YY′ of the battery charging case 1 and is fixedly connected to the screening plate 251. The second drive assembly 26 is connected to the transmission rack 252 and is configured to drive the screening plate 252 to move along the width direction YY′ of the battery charging case 1 through the transmission rack 252.

The screening plate 251 is used to block the battery installation through slot 212a; the specific preparation material for screening plate 251 can be, but is not limited to, plastics or plastic cement, etc.

The designed screening plate 251 is used to block the battery installation through slot 212a, and when the second drive assembly 26, through the transmission rack 252, drives the screening plate 251 to move to the screening port 251a along the width direction YY′ of the battery charging case 1 to align with the battery installation through slot 212a, batteries that meet the model requirements can pass through the screening port 251a of screening plate 251; when the second drive assembly 26, through the transmission rack 252, drives the screening plate 251 to move to the screening port 251a along the width direction YY′ of battery charging case 1 to be offset from the battery installation through slot 212a, batteries to be charged that do not meet the model requirements can pass through the screening port 251a of screening plate 251, such that the batteries that meet the model requirements and the batteries to be charged that do not meet the model requirements can be effectively screened.

Specifically, as shown in FIG. 4-5, the transmission rack 252 is integrally formed with the screening plate 251, and the transmission rack 252 can be integrated with the screening plate 251 through, but not limited to, injection molding or 3D printing, thus effectively reducing the processing difficulty between the transmission rack 252 and the screening plate 251.

Further, as shown in FIG. 4-5, the screening assembly 25 further comprises a buffer 253, and the buffer 253 is connected to the side of the screening plate 25 facing away from the battery installation through slot 212a and is disposed corresponding to the screening port 251a.

The batteries that meet the model requirements and the batteries that do not meet the model requirements, when falling from the screening port 251a, will fall onto the buffer 253, and the buffer 253 is used to provide buffering force to reduce the possibility of other components and the batteries being damaged by the impact force from the batteries that meet the model requirements and the batteries that do not meet the model requirements falling from the screening port 251a. The specific manifestations of the buffer 253 can be, but are not limited to, the following embodiments.

In the first embodiment, the buffer 253 comprises a buffer partition that is arranged in a cantilever shape and integrally formed with the screening plate 251. The buffer partition 2531 can be integrated with the screening plate 251 through, but not limited to, injection molding or 3D printing. The buffer 253 is designed as a cantilevered buffer partition 2531, with one end of the buffer partition 2531 suspended away from the screening plate 251, so that the batteries that meet the model requirements and batteries to be charged that do not meet the model requirements fall from the screening port 251a onto the buffer partition 2531, driving the buffer partition 2531 to constantly swing, such that a portion of the energy of the falling batteries that meet the model requirements and the falling batteries to be charged that do not meet the model requirements during the process of falling can be consumed, and the design serves as a buffer to reduce the possibility of other components and the batteries being damaged by the impact force from such falling batteries that meet the model requirements and such falling batteries that do not meet the model requirements.

In the second embodiment, the buffer 253 includes a partition (not shown in the drawing) and a buffer pad (not shown in the drawing), and the partition comprises a semi-bracket structure, and both ends of the partition are fixedly connected to the screening plate 251, and the buffer pad is disposed on the side of the partition facing the screening port 251a; the preparation material of buffer pad can be, but is not limited to, elastic rubber. A partition and buffer pad are designed, and the partition is used to provide support for the buffer pad, the batteries that meet the model requirements and the batteries to be charged that do not meet the model requirements fall from the screening port 251a onto the buffer pad, causing the buffer pad to deform, such that a portion of energy of the falling batteries that meet the model requirements and the falling batteries to be charged that do not meet the model requirements during the process of falling can be consumed, and the design serves as a buffer to reduce the possibility of other components and the batteries being damaged by the impact force from such falling batteries that meet the model requirements and such falling batteries that do not meet the model requirements.

Further, as shown in FIG. 4-5, the charging module 20 further comprises a limit structure 27, and the limit structure 27 is disposed on the first bracket 212 and the screening plate 251 and is configured to control the movement of the screening plate 251 along the width direction YY′ of the battery charging case under the action of the second drive assembly 26 within a preset range. The specific value of the “preset range” is not limited here, as long as it is larger than or equal to the minimum stroke that the screening plate 251 can move along the width direction YY′ of the battery charging case to the screening port 251a to align with and to be offset from the battery installation through slot 212a.

Specifically, as shown in FIG. 4-5, the limit structure 27 comprises a limit flange 271, and a limit groove 272 extending along the width direction YY′ of the battery charging case 1, the limit flange 271 is disposed on one of the first bracket 212 and the screening plate 251, the limit groove 272 is disposed on the other of the first bracket 212 and the screening plate 251, and the limit flange 271 is embedded in the limit groove 272. The limit flange 271 can be integrated with one of the first bracket 212 and the screening plate 251 through, but not limited to, injection molding or 3D printing. The limit structure 27 is designed as a limit flange 271 and a limit groove 272, the second drive assembly 26 drives the screening plate 251 to move along the width direction YY′ of the battery charging case 1, and the limit flange 271 is disposed against the groove wall of the limit groove 272 in the width direction YY′ of the battery charging case 1, in order to restrict the screening plate 251 from continuing to move along the width direction YY′ of the battery charging case 1, such that the movement stroke of the screening plate 251 in the width direction YY′ of battery charging case 1 falls within the preset range.

Further, as shown in FIG. 4-5, the second drive assembly 26 comprises a second motor 261 installed on the first bracket 212 and a transmission gear 262 that is fixedly connected to the drive shaft of the second motor 261 and meshes with the transmission rack 252.

The specific model of the second motor 261 is not limited here, and designers can make reasonable choices according to actual needs. The specific connection method between the second motor 261 and the first bracket 212 is not limited here, and designers can make reasonable choices according to actual needs, for example, when the second motor 261 is detachably connected to the first bracket 212, the second motor 261 can be fixedly connected to the first bracket 212 through, but not limited to, at least one of screw connection, snap-in connection, or plug-in connection and, for example, when the second motor 261 is not detachably connected to the first bracket 212, the second motor 261 can be fixedly connected to the first bracket 212 through, but not limited to, adhesive bonding.

The second motor 261 and transmission gear 262 are designed, the second motor 261 drives the transmission gear 262 to rotate, and the rotating transmission gear 262 drives the transmission rack 252 that meshes with it to move along the width direction YY′ of the battery charging case 1, the transmission rack 252 drives the screening plate 251 fixedly connected to it to move along the width direction YY′ of the battery charging case 1; when the screening plate 251 moves along the width direction YY′ of the battery charging case 1 to the screening port 251a to align with the battery installation through slot 212a, the batteries that meet the model requirements can pass through the screening port 251a; when the screening plate 251 moves along the width direction YY′ of the battery charging case 1 to the screening port 251a to be offset from the battery installation through slot, the batteries to be charged that do not meet the model requirements can pass through screening port 251a, effectively screening the batteries that meet the model requirements and the batteries to be charged that do not meet the model requirements.

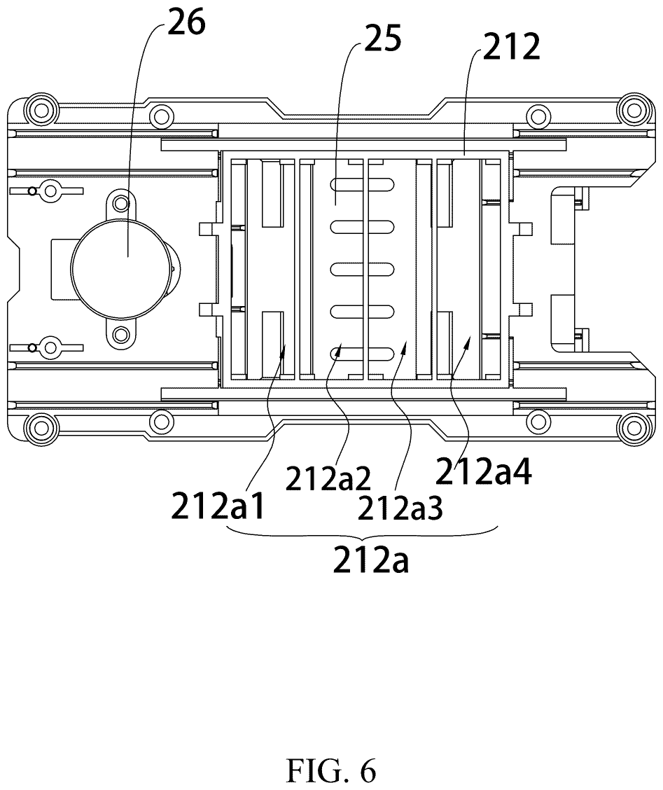

As shown in FIG. 6-10, understandably, the number of battery installation through slot 212a on the first bracket 212 can be one or multiple (two or more). When there is one battery installation through slot 212a on the first bracket 212, for a single charging process of charging module 20, the charging assembly of charging module 20 can only charge one battery to be charged that meets the model requirements. When there are multiple battery installation through slots 212a on the first bracket 212, for a single charging process of charging module 20, the charging assembly of charging module 20 can simultaneously charge multiple batteries to be charged that meet the model requirements.

There are multiple battery installation through slots 212a on the first bracket 212, and the multiple battery installation through slots include a first through slot 212a1, a second through slot 212a2, a third through slot 212a3, and a fourth through slot 212a4 arranged along the width direction of the battery charging case 1; the screening plate 251 comprises a plate body 2511 and a blocking plate 2512, wherein the plate body 2511 extends along the width direction YY′ of the battery charging case 1 and is slidably connected to the first bracket 212, while the plate body 2511 comprises a through hole that penetrates the plate body 2511 in a height direction ZZ′ of the battery charging case 1, and the blocking plate 2512 is located inside the through hole and is connected to the plate body 2511 to divide the through hole into two above screening ports 251a (two screening ports 251a include a first screening port 251a1 and a second screening port 251a2). Along the width direction YY′ of the battery charging case 1, the width dimension of blocking plate 2512 is larger than that of the first through slot 212a1, the second through slot 212a1, the third through slot 212a1, and the fourth through slot 212a1; the second motor 261 is configured to drive the screening plate 251 to perform reciprocating motion along the width direction YY′ of the battery charging case, such that the charging module 20 effectively screens multiple batteries to be charged simultaneously, improving the screening efficiency.

It should be noted that the charging module 20 also includes a clamping assembly (not shown in the drawing), and the clamping assembly serves as a structural component of the charging module 20 for clamping the batteries to be charged meeting the model requirements that fall into the battery installation through slot 212a, in order to realize the relative fixation between the batteries to be charged that meet the model requirements and the first bracket 212. Before the second motor 261 drives the screening plate 251 to perform reciprocating motion along the width direction YY′ of the battery charging case 1, the clamping assembly first clamps and fixes the batteries to be charged that fall into the first through slot 212a1, the second through slot 212a2, the third through slot 212a3, and the fourth through slot 212a4, and then the batteries to be charged that meet the model requirements can be fixed by the clamping assembly, while the batteries to be charged that do not meet the model requirements cannot be fixed by the clamping assembly. Subsequently, the second motor 261 drives the screening plate 251 to perform reciprocating motion along the width direction YY′ of the battery charging case 1 and during the process, as shown in FIG. 6-10, as long as the first screening port 251a1/second screening port 251a2 is offset from the first through slot 212a1, second through slot 212a2, third through slot 212a3, and fourth through slot 212a4, and the gap formed by the first screening port 251a1/second screening port 251a2 and the first through slot 212a1, second through slot 212a2, third through slot 212a3, and fourth through slot 212a4 is larger than the size of the batteries to be charged that do not meet the model requirements, such batteries to be charged that do not meet the model requirements can pass through the first screening port 251a1/second screening port 251a2. As shown in FIG. 6-10, when the first screening port 251a1/second screening port 251a2 is aligned with the first through slot 212a1, second through slot 212a2, third through slot 212a3, and fourth through slot 212a4, the batteries to be charged that are not fixed by the clamping assembly and do not meet the model requirements can also pass through the first screening port 251a1/second screening port 251a2.

Further, as shown in FIG. 4-5, the blocking plate 2512 is integrally formed with the plate body 2511. The blocking plate 2512 can be integrated with the plate body 2511 through, but not limited to, injection molding or 3D printing, effectively reducing the processing difficulty between the blocking plate 2512 and the plate body 2511.

Further, as shown in FIG. 4-5, the blocking plate 2512 is provided with a hollow hole 2512a. The hollow hole 2512a is a long rectangular hole extending along the width direction YY′ of the battery charging case 1, there are multiple hollow holes 2512a, and multiple hollow holes 2512a are arranged at intervals along the length direction XX′ of the battery charging case 1. The hollow holes 2512a are designed to save materials and reduce costs, but also serve as a reinforcing rib to enhance the structural strength of blocking plate 2512.

As shown in FIG. 11, in the second aspect, the present application proposes a battery charging case 1, comprising a feeding module 10 used to accommodate the batteries to be charged, a discharging module 30 used to accommodate the fully charged batteries, and an above-mentioned charging module 20; the discharging port of the feeding module 10 is connected to the feeding port of compartment body 211, and the discharging port of compartment body 211 is connected to the feeding port of discharging module 30.

The external battery to be charged flows into the chamber of the feeding compartment 11 of the feeding module 10 from the feeding port of the feeding module 10, and the feeding compartment 11 of the feeding module 10 effectively stores the batteries to be charged. The batteries to be charged stored in the feeding compartment 11 of the feeding module 10 flow out of the chamber of the feeding compartment 11 of the feeding module 10 through the discharging port of the feeding module 10 and into the chamber of the compartment body 211 through the feeding port of the feeding module 211, and the batteries to be charged directly drops into the battery installation through slot 212a. Firstly, the clamping assembly of charging module 20 performs clamping operation, the batteries to be charged that meet the model requirements are clamped and fixed by the clamping assembly, while the batteries to be charged that do not meet the model requirements are not clamped and fixed by the clamping assembly. Subsequently, the second motor 261 drives the screening plate 251 to perform reciprocating motion along the width direction YY′ of the battery charging case 1, and the batteries to be charged in the battery installation through slot 212a that do not meet the model requirements pass through the screening port 251a. After all the batteries to be charged in the battery installation through slot that do not meet the model requirements are screened, the charging assembly of charging module 20 performs charging operation, the charging assembly charges the batteries to be charged in the battery installation through slot 212a that meet the model requirements and are fixed by the clamping assembly and, after charging is completed, the clamping assembly releases the fully charged batteries, the second motor 261 drives screening plate 251 to move back and forth along the width direction YY′ of the battery charging case 1, and the fully charged batteries in the battery installation through slot 212a that meet the model requirements pass through the screening port 251a. Fully charged batteries that meet the model requirements flow out of the compartment body 211 under their own gravity from the discharging port of compartment body 211 and into the chamber of the discharging compartment 31 of discharging module 30, and the discharging compartment 31 of discharging module 30 can effectively store fully charged batteries that meet the model requirements.

The battery charging case 1 in the embodiment of the present application comprises the above-mentioned charging module 20, and can effectively screen the batteries to be charged that do not meet the model requirements.

The above are only the preferred embodiments of the present application and are not intended to limit the present application. Any modifications, equivalent substitutions, and improvements made within the spirit and principles of the present application shall be included within the scope of protection hereof.

What is claimed is:

1. A charging module, used for a battery charging case, wherein the charging module comprises:
a charging compartment, comprising a compartment body and a first bracket, the first bracket is installed in a chamber of the compartment body and comprises a battery installation through slot for accommodating the batteries to be charged;
a screening assembly, installed on the first bracket and located at a discharging side of the battery installation through slot, and comprising a screening port for the battery to flow through;
a second drive assembly, installed on the first bracket and is drivingly connected to the screening assembly, wherein the second drive assembly is configured to drive the screening assembly to move along a width direction of the battery charging case; when the screening assembly moves to the screening port to align with the battery installation through slot, batteries that meet model requirements pass through the screening port; when the screening assembly moves to the screening port to be offset from the battery installation through slot, batteries to be charged that do not meet model requirements pass through the screening port.

2. The charging module of claim 1, wherein the screening assembly comprises:
a screening plate extending along the width direction of the battery charging case and sliding connected to the first bracket, and comprising a screening port;
a transmission rack extending along the width direction of the battery charging case and fixedly connected to the screening plate;
wherein the second drive assembly is drivingly connected to the transmission rack and is configured to drive the screening plate to move along the width direction of the battery charging case through the transmission rack.

3. The charging module of claim 2, wherein the screening assembly further comprises a buffer, and the buffer is connected to the side of the screening plate facing away from the battery installation through slot and is disposed corresponding to the screening port.

4. The charging module of claim 3, wherein the buffer comprises a buffer partition that is arranged in a cantilever shape and integrally formed with the screening plate.

5. The charging module of claim 2, wherein the transmission rack is integrally formed with the screening plate.

6. The charging module of claim 2, wherein the charging module further comprises a limit structure, and the limit structure is disposed on the first bracket and the screening plate and is configured to control the movement of the screening plate along the width direction of the battery charging case under the action of the second drive assembly within a preset range.

7. The charging module of claim 3, wherein the charging module further comprises a limit structure, and the limit structure is disposed on the first bracket and the screening plate and is configured to control the movement of the screening plate along the width direction of the battery charging case under the action of the second drive assembly within a preset range.

8. The charging module of claim 4, wherein the charging module further comprises a limit structure, and the limit structure is disposed on the first bracket and the screening plate and is configured to control the movement of the screening plate along the width direction of the battery charging case under the action of the second drive assembly within a preset range.

9. The charging module of claim 5, wherein the charging module further comprises a limit structure, and the limit structure is disposed on the first bracket and the screening plate and is configured to control the movement of the screening plate along the width direction of the battery charging case under the action of the second drive assembly within a preset range.

10. The charging module of claim 6, wherein the limit structure comprises a limit flange, and a limit groove extending along the width direction of the battery charging case, the limit flange is disposed on one of the first bracket and the screening plate, the limit groove is disposed on the other of the first bracket and the screening plate, and the limit flange is embedded in the limit groove.

11. The charging module of claim 2, wherein the second drive assembly comprises:
a second motor installed on the first bracket;
a transmission gear that is fixedly connected to a drive shaft of the second motor and meshes with the transmission rack.

12. The charging module of claim 3, wherein the second drive assembly comprises:
a second motor installed on the first bracket;
a transmission gear that is fixedly connected to a drive shaft of the second motor and meshes with the transmission rack.

13. The charging module of claim 4, wherein the second drive assembly comprises:
a second motor installed on the first bracket;
a transmission gear that is fixedly connected to a drive shaft of the second motor and meshes with the transmission rack.

14. The charging module of claim 5, wherein the second drive assembly comprises:
a second motor installed on the first bracket;
a transmission gear that is fixedly connected to a drive shaft of the second motor and meshes with the transmission rack.

15. The charging module of claim 11, wherein there are multiple battery installation through slots, and the multiple battery installation through slots comprise a first through slot, a second through slot, a third through slot, and a fourth through slot arranged along the width direction of the battery charging case;
the screening plate comprises a plate body and a blocking plate, wherein the plate body extends along the width direction of the battery charging case and is slidably connected to the first bracket, while the plate body comprises a through hole that penetrates the plate body in a height direction of the battery charging case, and the blocking plate is located inside the through hole and is connected to the plate body to divide the through hole into two screening ports;
along the width direction of the battery charging case, the width dimension of the blocking plate is larger than that of the first through slot, the second through slot, the third through slot, and the fourth through slot;
wherein the second motor is configured to drive the screening plate to perform reciprocating motion along the width direction of the battery charging case.

16. The charging module of claim 15, wherein the blocking plate is integrally formed with the plate body.

17. The charging module of claim 15, wherein the blocking plate is provided with a hollow hole.

18. A battery charging case, comprising:
a feeding module used to accommodate the batteries to be charged;
the charging module of claim 1;
a discharging module used to accommodate the fully charged batteries;
the discharging port of the feeding module is connected to the feeding port of the compartment body, and the discharging port of the compartment body is connected to the feeding port of the discharging module.
